(19) United States
(12) Patent Application Publication
(10) Pub. No.: US 2024/0335878 A1
(43) Pub. Date: Oct. 10, 2024

(54) MANUFACTURING METHOD OF 3D ELECTRODE, CURRENT COLLECTOR FOR MICRO-SUPERCAPACITOR USING LASER DIRECT ENERGY DEPOSITION

(71) Applicant: CHUNG ANG UNIVERSITY INDUSTRY ACADEMIC COOPERATION FOUNDATION, Seoul (KR)

(72) Inventors: Jung-bin IN, Seoul (KR); Van-chau TRAN, Seoul (KR)

(21) Appl. No.: 18/748,319

(22) Filed: Jun. 20, 2024

Related U.S. Application Data
(63) Continuation of application No. PCT/KR2024/003424, filed on Mar. 19, 2024.

(30) Foreign Application Priority Data
Apr. 10, 2023 (KR) 10-2023-0046568

(51) Int. Cl. B22F 10/28; B22F 10/62; B33Y 10/00; B33Y 40/10; B33Y 40/20; B33Y 80/00; C25D 9/02; H01G 11/86

(52) U.S. Cl. CPC B22F 10/28; B22F 10/62; B33Y 10/00; B33Y 40/10; B33Y 40/20; B33Y 80/00; C25D 9/02; H01G 11/86; B22F 2301/15; B22F 2998/10

(57) ABSTRACT

The present disclosure relates to a manufacturing method of a micro 3D current collector using laser direct energy deposition and a manufacturing method of a 3D electrode for a supercapacitor, particularly to a manufacturing method of a micro 3D current collector using laser direct energy deposition where micro-metallic structures are directly printed onto a substrate using a laser-based direct energy deposition process, and then used as the current collectors of the micro-supercapacitors. The current collector with printed micro-metallic wires possesses high electric conductivity and a high aspect ratio as well as a larger surface area due to the extensive surface area of the wires, making it suitable for depositing energy storage active materials.

### BACKGROUND

### Technical Field

The present disclosure relates to a manufacturing method of a micro 3D current collector using laser direct energy deposition and a manufacturing method of a 3D electrode for a supercapacitor.

### Related Art

Electrochemical capacitors represent an energy storage system in-between dielectric capacitors and batteries. Due to high energy density compared to conventional dielectric capacitors and high power density compared to batteries, electrochemical capacitors have attracted considerable interests.

Particularly, micro-supercapacitors are well suited as a portable and lightweight power source that is applicable to micro-electromechanical systems (MEMS), small robots, wearable e-textiles and implantable medical devices.

Typically, supercapacitors consist of electrode materials, electrolyte, separators and current collectors. Among these components, electrode materials are the most crucial components, which govern the overall electrochemical performance of supercapacitors.

Ideal supercapacitor electrode materials require for diverse characteristics including high surface area, well-controlled porosity, high electrical conductivity, desirable electroactive sites, high thermal and chemical stability, low manufacturing cost and facile manufacturing processes.

Micro-metallic structures with high electrical conductivity are diversely applicable in various fields such as electrochemical electrodes, MEMS, 3D interconnectors, thermal management devices, bio-medical implants.

Micropower sources (microenergy storage devices) in medical, biological and environmental applications are used for portable and wearable electronics, which are in high demand. Micro-supercapacitors are one of the promising micropower sources.

3D electrodes can overcome the geometric limitations of conventional 2D electrodes, thereby possessing higher energy storage performance.

Metal current collectors are well-suited for micro-supercapacitors due to their high electrical conductivity, flexibility and favorable mechanical properties.

Conventional multilayer coating techniques can implement 3D microelectrode structures to a limited extent. However, they are not practical due to their high production time and cost.

Thus, methods for manufacturing current collectors with cost-effective materials using additive manufacturing (3D printing) are also being explored.

SLA or SLM, which are representative metal printing methods, enable the manufacture of 3D microstructure in a powder bed. However, they have drawbacks of being difficult to print directly onto various types of substrates.

### SUMMARY

### Technical Problem

Therefore, the present disclosure is contrived to solve conventional issues as described above. According to an embodiment of the present disclosure, it aims to manufacture a micro-metallic wire using laser-based direct energy deposition.

Further, according to an embodiment of the present disclosure, it aims to manufacture a 3D current collector for a micro-supercapacitor with a high aspect ratio using laser-based direct energy deposition.

Yet further, according to an embodiment of the present disclosure, it aims to manufacture a micro-supercapacitor with a directly energy deposited current collector and an electroplated active material.

In addition, according to an embodiment of the present disclosure, it aims to utilize a laser-based direct energy deposition process to directly print micro-metallic structures onto a substrate, which are then used as the current collectors of supercapacitors.

Further, according to an embodiment of the present disclosure, it aims to provide a manufacturing method of a micro 3D current collector using laser direct energy deposition. The current collector with printed micro-metallic wires possesses high electric conductivity and a high aspect ratio as well as a larger surface area due to the extensive surface area of the wires, thereby making it suitable for depositing energy storage active materials.

According to an embodiment of the present disclosure, it aims to provide a manufacturing method of a micro 3D current collector using laser direct energy deposition and a manufacturing method of a 3D electrode for a supercapacitor. Micro wires are electroplated with reduced graphene oxide and polyaniline to provide a large active surface and enable fast reversible redox reactions, thereby significantly improving the capacitance of micro-supercapacitor.

Meanwhile, technical objects to be achieved in the present invention are not limited to the aforementioned technical objects, and other technical objects, which are not mentioned above, will be apparently understood to a person having ordinary skill in the art from the following description.

### Technical Solution

A first aspect of the present disclosure relates to a manufacturing method of a micro 3D metallic structure and may be achieved by a manufacturing method of a micro 3D metallic structure using laser direct energy deposition including printing a plurality of micro wires on a substrate using laser direct energy deposition onto the substrate.

In addition, this method further may include a step of laser cutting the substrate into an interdigital pattern or combo structure before the printing step.

Further, the laser direct energy deposition may involve supplying metal powder onto the substrate through a nozzle of a laser direct energy deposition system while irradiating a laser beam to the substrate, to perform printing such that the longitudinal direction of the micro wires are perpendicular to the planar direction of the substrate.

In addition, the laser direct energy deposition system may include a jig that fixes the substrate; a moving stage that moves the jig in the Y, X, Y and Z; a nozzle that supplies metal powder to the substrate; and a laser irradiation module that irradiates a laser beam to the metal powder supplied to the substrate to perform printing.

Further, the diameter of the micro wires may ranges 80˜150 μm, and the height thereof ranges 1˜2 mm.

In addition, the metal powder may be nickel-based alloy powder with a particle size distribution of 15˜45 μm.

A second aspect of the present disclosure may be achieved by a micro 3D metallic structure manufactured by the manufacturing method according to the aforementioned first aspect of the present disclosure.

A third aspect of the present disclosure may be achieved by a micro 3D current collector with the micro 3D metallic structure micro 3D current collector with the micro 3D metallic structure according to the aforementioned second aspect of the present disclosure.

A fourth aspect of the present disclosure relates to a manufacturing method of a micro 3D electrode, and may be achieved by a manufacturing method of a 3D electrode for micro-supercapacitor comprising steps of manufacturing a current collector by the manufacturing method of a micro 3D metallic structure using laser direct energy deposition according to the aforementioned first aspect of the present disclosure; and depositing an active material onto a micro wire surface of the current collector.

In addition, the active material deposition step may include steps of depositing reduced graphene oxide, and depositing polyaniline.

Further, the reduced graphene oxide deposition step may involve electrochemically depositing reduced graphene oxide with a 3 electrode system using a graphene oxide aqueous suspension.

In addition, in the 3 electrode system, the current collector may be used as a working electrode, a Pt mesh may be used a counter electrode, and a saturated calomel electrode may be used as a reference electrode.

Further, the polyaniline deposition step may involve polymerizing aniline with a 3 electrode system using a mixed solution of sulfuric acid and aniline, and electrochemically depositing the polyaniline.

In addition, in the 3 electrode system, the electrode deposited with the graphene oxide may be used as a working electrode, a Pt mesh may be used as a counter electrode, and Ag/AgCl may be used as a reference electrode.

A fifth aspect of the present disclosure may be achieved by a micro-supercapacitor manufactured by the manufacturing method according to the aforementioned fifth aspect of the present disclosure.

A sixth aspect of the present disclosure may be achieved by a micro-supercapacitor including the 3D electrode according to the aforementioned sixth aspect of the present disclosure; and electrolyte.

### Advantageous Effects

According to the present disclosure, it is capable of manufacturing micro-metallic wires, 3D current collectors for micro-supercapacitors, and micro-supercapacitors electroplated with direct energy deposited current collectors and an electroplated active material.

In addition, according to the present disclosure, it is capable of utilizing a laser-based direct energy deposition process to directly print micro-metallic structures onto a substrate, which are then used as the current collectors of supercapacitors.

Further, according to a manufacturing method of a micro 3D current collector using laser direct energy deposition, it enables that current collector with printed micro-metallic wires possesses high electric conductivity and a high aspect ratio as well as a larger surface area due to the extensive surface area of the wires, thereby making it suitable for depositing energy storage active materials.

According to a manufacturing method of a micro 3D current collector using laser direct energy deposition and a manufacturing method of a 3D electrode for a supercapacitor, these enable that micro wires are electroplated with reduced graphene oxide and polyaniline to provide a large active surface and enable fast reversible redox reactions, thereby significantly improving the capacitance of micro-supercapacitor.

Meanwhile, advantageous effects to be obtained in the present disclosure are not limited to the aforementioned effects, and other effects, which are not mentioned above, will be apparently understood to a person having ordinary skill in the art from the following description.

### BRIEF DESCRIPTION OF THE DRAWINGS

The accompanying drawings of this specification exemplify a preferred embodiment of the present disclosure, the spirit of the present disclosure will be more clearly understood from the following detailed description taken in conjunction with the accompanying drawings, and thus it will be understood that the present disclosure is not limited to only contents illustrated in the accompanying drawings.

FIG. 1 shows a flowchart of a manufacturing method of a supercapacitor with a micro 3D current collector using laser direct energy deposition according to an embodiment of the present disclosure,

FIG. 2 shows a schematic view of a substrate patterning process according to the present disclosure,

FIG. 3 and FIG. 4 show schematic views of a laser direct energy deposition system for manufacturing a micro wire according to embodiments of the present disclosure,

FIG. 5 to FIG. 7 show, respectively, a perspective view, an enlarged view, and a micro wire SEM image of a micro current collector with a plurality of printed micro wires according to the present disclosure,

FIG. 8 shows a 3D electrode deposited with reduced graphene oxide and polyaniline according to an embodiment of the present disclosure,

FIG. 9 shows an SEM image in a state that reduced graphene oxide is deposited on a micro wire according to an embodiment of the present disclosure,

FIG. 10 shows an SEM image in a state that a micro wire deposited with reduced graphene oxide is subsequently deposited with polyaniline according to an embodiment of the present disclosure,

FIG. 11 shows a schematic view of a supercapacitor using a micro 3D electrode according to an embodiment of the present disclosure,

FIG. 12 shows a CV test graph of a supercapacitor according to an embodiment of the present disclosure, and

FIG. 13 shows show a charge-discharge curve graph of a supercapacitor according to an embodiment of the present disclosure.

### DETAILED DESCRIPTION

### Best Mode

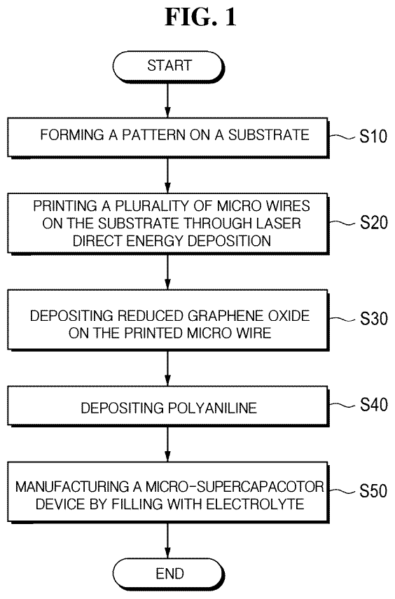

Hereinafter, described is a manufacturing method of a supercapacitor with a micro 3D current collector using laser energy deposition according to an embodiment of the present disclosure. FIG. 1 shows a flowchart of a manufacturing method of a supercapacitor with a micro 3D current collector using laser direct energy deposition according to an embodiment of the present disclosure.

Firstly, described is a manufacturing method of a 3D current collector with a 3D metallic structure 10 on which a plurality of micro wires 2 were printed.

In an embodiment of the present disclosure, a prepared substrate 1 is cut into an interdigital pattern or combo structure (S10). In a specific embodiment, a stainless steel SS316L substrate 1 is cut into an interdigital pattern or combo structure with a nanosecond pulse fiber laser.

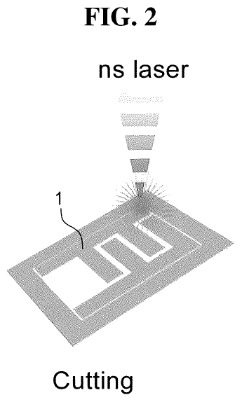

FIG. 2 shows a schematic view of a substrate patterning process according to the present disclosure. As shown in FIG. 2, a substrate may be cut into an interdigital pattern, and each electrode may be designed in the shape of two fingers.

In addition, on the substrate (electrode layer) 1 with this pattern, a plurality of micro wires 2 is printed and deposited on the substrate 1 using laser direct energy deposition (S20).

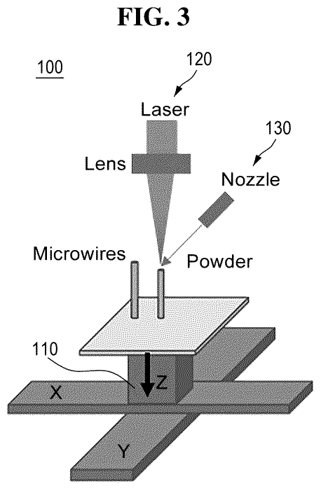

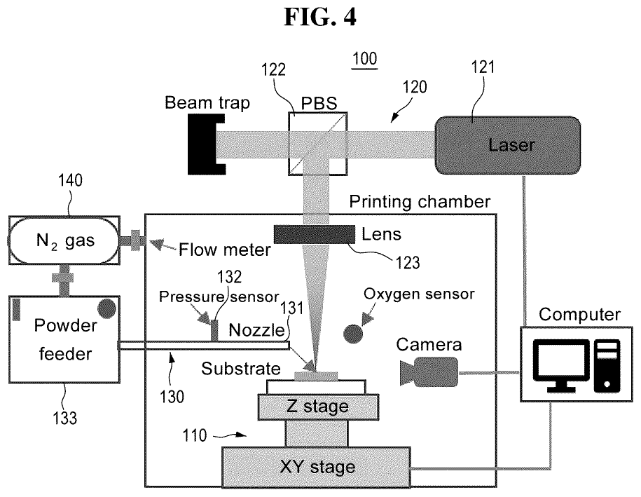

FIG. 3 and FIG. 4 show schematic views of a laser direct energy deposition system for manufacturing a micro wire according to embodiments of the present disclosure.

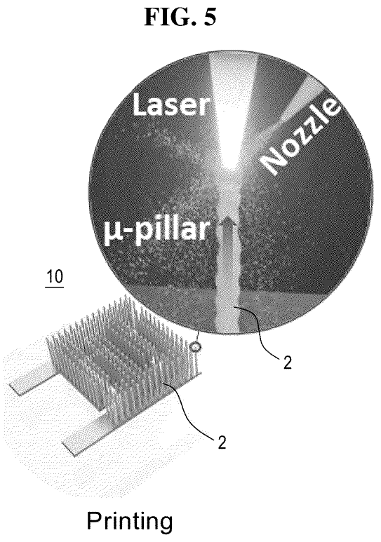

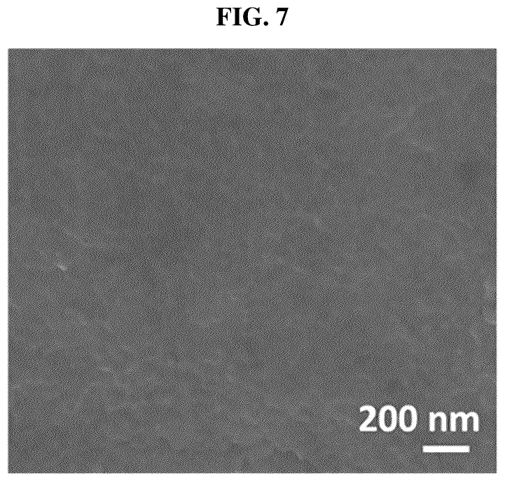

FIG. 5 to FIG. 7 show, respectively, a perspective view, an enlarged view, and a micro wire SEM image of a micro current collector with a plurality of printed micro wires according to the present disclosure.

As shown in FIG. 4, the laser direct energy deposition involves supplying metal powder onto a substrate 1 through a nozzle 131 of a laser direct energy deposition system 100 while irradiating a laser beam to the substrate, to perform printing such that the longitudinal direction of the micro wires 2 are perpendicular to the planar direction of the substrate 1.

This laser direct energy deposition system 100 utilizes a small beam spot diameter (˜22 μm) and laser modulation. The metal powder according to an embodiment of the present disclosure may be a nickel-based alloy powder with a spherical particle size distribution of 15˜ 45 μm. However, all metal powder capable of laser direct energy deposition may be used.

As shown in FIG. 4, the laser direct energy deposition system 100 may include a jig that fixes the substrate 1 and a moving stage 110 that moves the jig in the Y, X, Y and Z. In addition, this may include a power supply module 130 that supplies metal power to the substrate 1. The powder supply module 130 may be configured to include a powder supply portion 133, a pressure sensor 132 that measures the supply pressure, and a nozzle 131 that injects metal powder.

In addition, a laser irradiation module 120 is configured to irradiate a laser beam to the metal powder supplied to the substrate 1 to perform printing. This may be configured to include a laser oscillator 121, a PBS 122, and a lens 123.

By applying this laser direct energy deposition, for instance, 150 micro wires (diameter: 110 μm, height: 1.5 mm) 2 are printed onto the substrate 1, forming a 3D metal interdigital current collector. Nitrogen gas is supplied through a protective gas supply portion 140 to protect powder flow and the printing area.

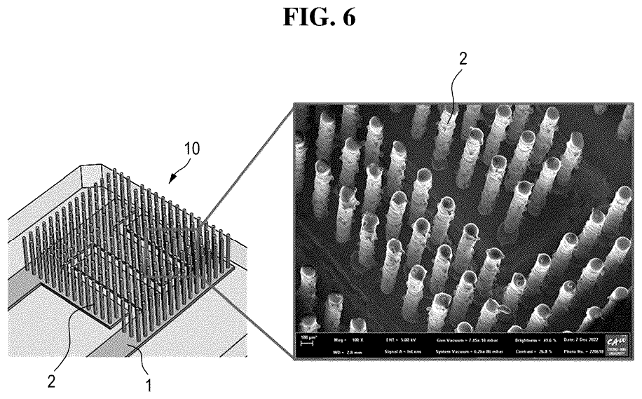

As shown in FIG. 6, in the embodiment of the present disclosure, it can be seen that 150 micro wires (75 micro wires 2 per electrode) with a diameter of 110 μm and a height of 1.5 mm are printed in an interdigital pattern on the substrate 1. Each electrode is designed in the shape of two fingers, and three rows of micro wires 2 are evenly printed on each finger-shaped electrode.

### Description of Embodiments

In an embodiment of the present disclosure, an active material may be electroplated on a micro 3D current collector using the aforementioned laser direct energy deposition.

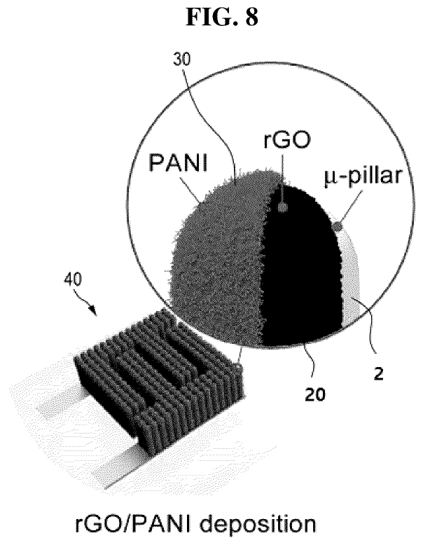

FIG. 8 shows a 3D electrode deposited with reduced graphene oxide and polyaniline according to an embodiment of the present disclosure.

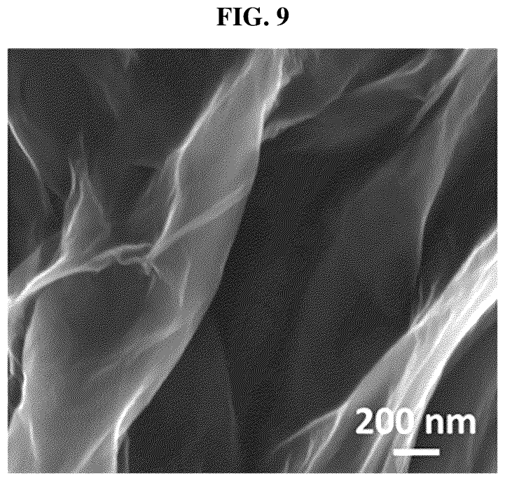

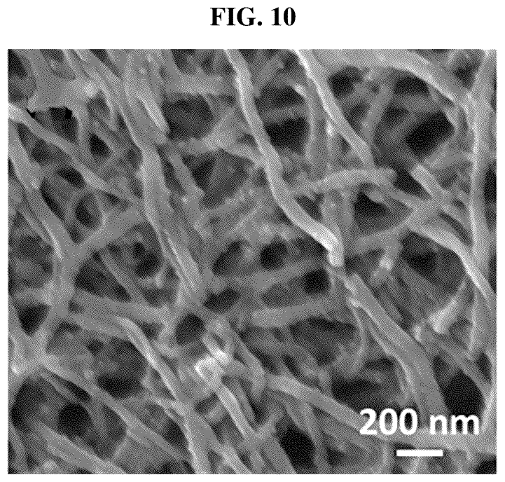

In addition, FIG. 9 shows an SEM image in a state that reduced graphene oxide is deposited on a micro wire according to an embodiment of the present disclosure, and FIG. 10 shows an SEM image in a state that a micro wire deposited with reduced graphene oxide is subsequently deposited with polyaniline according to an embodiment of the present disclosure.

As shown in FIG. 8, it is seen that the active material deposition according to an embodiment of the present disclosure may include steps of depositing reduced graphene oxide 20 (S30), and depositing polyaniline 30 (S40).

The reduced graphene oxide 20 and polyaniline 30 are deposited on the micro wires 2, increasing the active surface area and providing pseudocapacitor performance.

In the deposition of reduced graphene oxide 20 according to an embodiment of the present disclosure, the reduced graphene oxide 20 was first deposited using a 0.1M LiCIO₄ graphene oxide aqueous suspension (5 mg/ml) in a 3 electrode system at a potential of −12.V for 8 minutes.

In the 3 electrode system, a 3D printing current collector 10 is used as a working electrode, a Pt mesh is used a counter electrode, and a saturated calomel electrode is used as a reference electrode. After the deposition process of the reduced graphene oxide 20, the deposited micro wires is rinsed with DI water and then dried in a convection oven at 50° C. for 2 hours.

In the deposition of polyaniline 30 according to an embodiment of the present disclosure, aniline is polymerized for 10 minutes in a 3 electrode system with a potential of 0.75 V using a solution mixed with 0.5M H₂SO4 and 0.01M aniline, and polyaniline 30 is deposited.

In the 3 electrode system, the electrode with graphene oxide from the previous step is used as a working electrode, a Pt mesh is used a counter electrode, and Ag/AgCl (sat. KCl) is used as a reference electrode. After the deposition process of the polyaniline 30, the deposited micro wires is rinsed with DI water for 30 minutes and then dried.

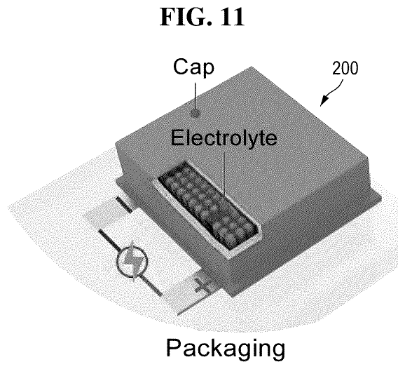

Then, a micro-supercapacitor 200 is manufactured by incorporating a manufactured 3D electrode 40 into electrolyte (S50). FIG. 11 shows a schematic view of a supercapacitor using a micro 3D electrode according to an embodiment of the present disclosure.

In other words, the manufactured 3D electrodes 40 are filled with 1M H₂SO₄ electrolyte to form the micro-supercapacitor 200 devices and characterize their electrochemical performance.

The electrochemical performance of the micro-supercapacitor 200 according to an embodiment of the present disclosure was tested within a potential window of 0˜ 0.8V.

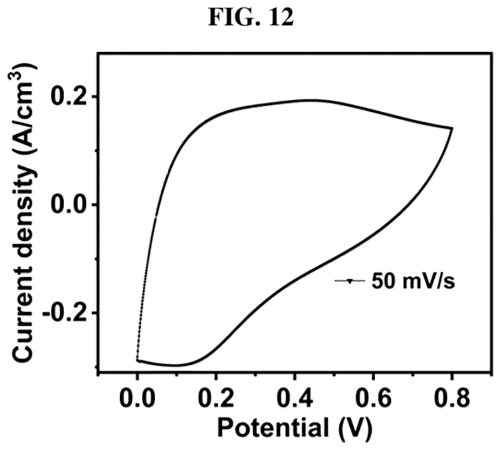

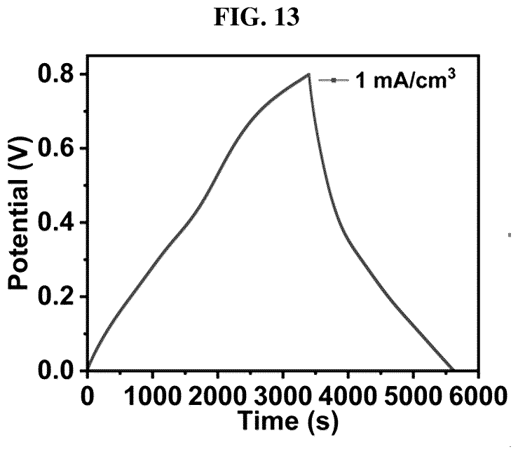

FIG. 12 shows a CV test graph of a supercapacitor according to an embodiment of the present disclosure, and FIG. 13 shows show a charge-discharge curve graph of a supercapacitor according to an embodiment of the present disclosure.

As shown in FIG. 12, it can be seen that the 3D printed micro-supercapacitor manufactured according to an embodiment of the present disclosure exhibits a wide CV graph area in the CV (Cylic voltammetry) test.

In addition, as shown in FIG. 13, it can be seen that the micro-supercapacitor manufactured according to an embodiment of the present disclosure exhibits a specific capacitance of 2.77 F/cm³ at 1 mA/cm3 in 1M H₂SO₄ electrolyte.

Furthermore, the apparatus and methods described above are not intended to be limited to the configurations and methods of the embodiments described above, but may be configured with optional combinations of all or portions of each embodiment so that various variations may be made.

1. As a manufacturing method of a micro 3D metallic structure, a manufacturing method of a micro 3D metallic structure using laser direct energy deposition comprising a step of:
printing a plurality of micro wires on a substrate by laser direct deposition onto the substrate.

2. The manufacturing method of a micro 3D metallic structure using laser direct energy deposition of claim 1 further comprising a step of:
laser cutting the substrate into an interdigital pattern or combo structure before the printing step.

3. The manufacturing method of a micro 3D metallic structure using laser direct energy deposition of claim 2, wherein
the laser direct energy deposition involves supplying metal powder onto the substrate through a nozzle of a laser direct energy deposition system while irradiating a laser beam to the substrate, to perform printing such that the longitudinal direction of the micro wires are perpendicular to the planar direction of the substrate.

4. The manufacturing method of a micro 3D metallic structure using laser direct energy deposition of claim 3, wherein
the laser direct energy deposition system comprises a jig that fixes the substrate; a moving stage that moves the jig in the Y, X, Y and Z; a nozzle that supplies metal powder to the substrate; and a laser irradiation module that irradiates a laser beam to the metal powder supplied to the substrate to perform printing.

5. The manufacturing method of a micro 3D metallic structure using laser direct energy deposition of claim 3, wherein
the diameter of the micro wires ranges 80˜150 μm, and the height thereof ranges 1˜2 mm.

6. The manufacturing method of a micro 3D metallic structure using laser direct energy deposition of claim 3, wherein
the metal powder is nickel-based alloy powder with a particle size distribution of 15˜ 45 μm.

7. A micro 3D metallic structure manufactured by the manufacturing method according to claim 1.

8. A micro 3D current collector with the micro 3D metallic structure according to claim 7.

9. As a manufacturing method of a micro 3D electrode, a manufacturing method of a 3D electrode for micro-supercapacitor comprising steps of
manufacturing a current collector by the manufacturing method of a micro 3D metallic structure using laser direct energy deposition according to claim 1; and
depositing an active material onto a micro wire surface of the current collector.

10. The manufacturing method of a 3D electrode for micro-supercapacitor of claim 9, wherein
the active material deposition step comprises steps of depositing reduced graphene oxide, and depositing polyaniline.

11. The manufacturing method of a 3D electrode for micro-supercapacitor of claim 10, wherein
the reduced graphene oxide deposition step involves electrochemically depositing reduced graphene oxide with a 3 electrode system using a graphene oxide aqueous suspension.

12. The manufacturing method of a 3D electrode for micro-supercapacitor of claim 11, wherein
in the 3 electrode system, the current collector is used as a working electrode, a Pt mesh is used a counter electrode, and a saturated calomel electrode is used as a reference electrode.

13. The manufacturing method of a 3D electrode for micro-supercapacitor of claim 10, wherein
the polyaniline deposition step involves polymerizing aniline with a 3 electrode system using a mixed solution of sulfuric acid and aniline, and electrochemically depositing the polyaniline.

14. The manufacturing method of a 3D electrode for micro-supercapacitor of claim 13, wherein
in the 3 electrode system, the electrode deposited with the graphene oxide is used as a working electrode, a Pt mesh is used as a counter electrode, and Ag/AgCl is used as a reference electrode.

15. A micro-supercapacitor manufactured by the manufacturing method according to claim 9.

16. A micro-supercapacitor including the 3D electrode according to claim 15; and electrolyte.
